(19) United States
(12) Patent Application Publication
(10) Pub. No.: US 2025/0376949 A1
(43) Pub. Date: Dec. 11, 2025

(54) INTEGRAL TURBINE WHEEL TO CLUTCH

(71) Applicant: Hamilton Sundstrand Corporation, Charlotte, NC (US)

(72) Inventors: James Scharfenberg, Rockford, IL (US); Jordan Pugliese, Woodstock, IL (US); August Metzler, Machesney Park, IL (US); Emilio Arroyo, Hoffman Estates, IL (US)

(21) Appl. No.: 18/734,870

(22) Filed: Jun. 5, 2024

(51) Int. Cl. F02C 7/277

(52) U.S. Cl. CPC F02C 7/277; F05D 2260/4023; F05D 2260/40311

(57) ABSTRACT

An air turbine starter for a gas turbine engine includes a clutch with an input component and an output component. The input component includes a base and turbine blades connected to the base and extending radially outward from the base relative to a center axis of the air turbine starter. An overrun mechanism connects the base of the input component to the output component and is configured to transfer rotational energy from the input component to the output component and prevent the output component from transferring rotational energy to the input component. A first end of a transfer shaft is connected to the output component of the clutch. A gear system is connected to a second end of the transfer shaft. An output shaft is mechanically connected to the transfer shaft by the gear system.

### BACKGROUND

The present disclosure relates to gas turbine engines and, more particularly, to air turbine starters. Many relatively large gas turbine engines, including turbofan engines, may use an air turbine starter to initiate gas turbine engine rotation.

The air turbine starter is typically mounted on an accessory gearbox which, in turn, is mounted on the engine or airframe. The air turbine starter generally includes a turbine section coupled to an output shaft by a gear system. The turbine section is coupled to a high-pressure fluid source, such as compressed air, to drive the output shaft through the gear system. Thus, when the high-pressure fluid source impinges upon the turbine section, the output shaft powers the gas turbine engine. The air turbine starter utilizes a clutch at start up to engage the output shaft with the gas turbine engine and to decouple the air turbine starter from the gas turbine engine once the gas turbine engine has been started and exceeds a predetermined output cut off speed of the output shaft. Air turbine starters have many moving parts, tight envelopes, and strict weight requirements from customers.

### SUMMARY

In one example of the disclosure, an air turbine starter for a gas turbine engine includes a clutch with an input component and an output component. The input component includes a base and turbine blades connected to the base and extending radially outward from the base relative to a center axis of the air turbine starter. An overrun mechanism connects the base of the input component to the output component and is configured to transfer rotational energy from the input component to the output component and prevent the output component from transferring rotational energy to the input component. A first end of a transfer shaft is connected to the output component of the clutch. A gear system is connected to a second end of the transfer shaft. An output shaft is mechanically connected to the transfer shaft by the gear system.

In another example of the disclosure, a clutch for an air turbine starter includes an input component and an output component. The input component includes a base and a plurality of turbine blades extending radially outward from the base relative to a center axis. An overrun mechanism connects the base of the input component to the output component and is configured to transfer rotational energy from the input component to the output component and prevent the output component from transferring rotational energy to the input component.

In another example of the disclosure, a turbine section of an air turbine starter includes a clutch. The clutch includes an input component and an output component. The input component comprises a base and turbine blades connected to the base and extending radially outward from the base relative to a center axis of the air turbine starter. An overrun mechanism connects the base of the input component to the output component and is configured to transfer rotational energy from the input component to the output component and prevent the output component from transferring rotational energy to the input component.

Persons of ordinary skill in the art will recognize that other aspects and embodiments of the present disclosure are possible in view of the entirety of the present disclosure, including the accompanying figures.

### BRIEF DESCRIPTION OF THE DRAWINGS

FIG. 1 is a cross-sectional view of an air turbine starter.

FIG. 2 is a cross-sectional view of a sprag clutch of an air turbine starter with a turbine integrated into the sprag clutch.

FIG. 3A is a cross-sectional view of a synchronous engagement clutch of the air turbine starter in an engaged position and with a turbine integrated into the synchronous engagement clutch.

FIG. 3B is a cross-sectional view of the synchronous engagement clutch of FIG. 3A in an overrun position.

While the above-identified drawing figures set forth one or more embodiments, other embodiments are also contemplated. It should be understood that numerous other modifications and embodiments can be devised by those skilled in the art, which fall within the scope and spirit of the principles of the claims. The figures may not be drawn to scale, and applications and embodiments may include features and components not specifically shown in the drawings.

### DETAILED DESCRIPTION

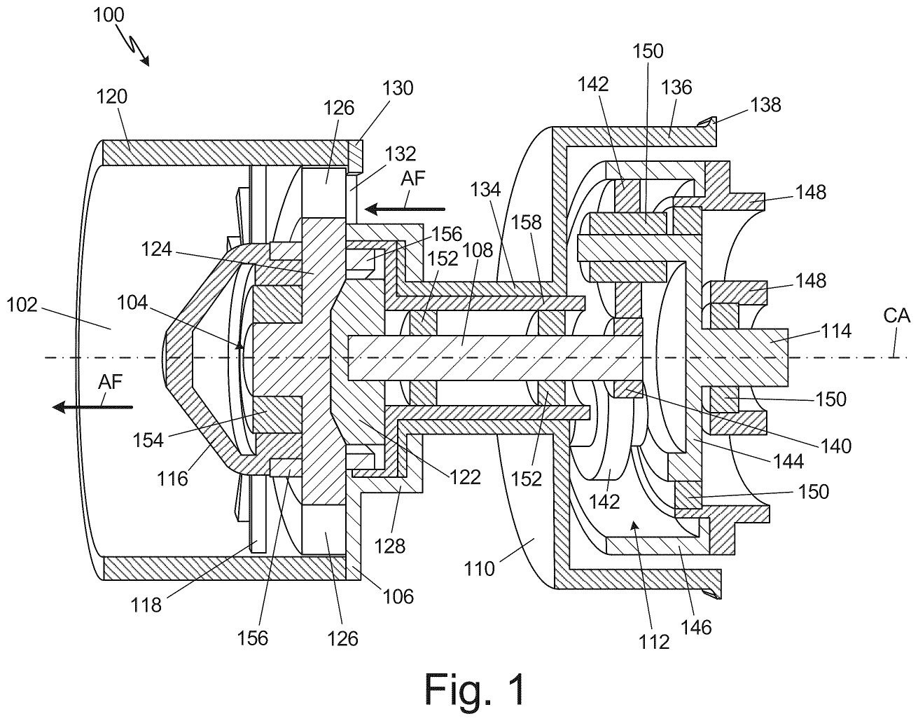

An air turbine starter can be mounted to a gas turbine engine of an aircraft. As the air turbine starter is carried by the gas turbine engine, reducing the weight and size of the air turbine starter will translate into a weight reduction and increased fuel efficiency of the aircraft. As discussed below with reference to FIGS. 1-3B, the air turbine starter includes a turbine that is incorporated into a clutch. As the clutch and the turbine are combined into a single section of the air turbine starter, the air turbine starter is significantly lighter and more compact than prior air turbine starters.

FIG. 1 is a cross-sectional view of air turbine starter 100. As shown in FIG. 1, air turbine starter 100 can include discharge housing 102, clutch 104, center housing 106, transfer shaft 108, output housing 110, gear system 112, and output shaft 114. Discharge housing 102 can include hub 116, struts 118, and outer casing 120. Clutch 104 includes output component 122 and input component 124 with base 125 and turbine blades 126. Center housing 106 can include inner casing 128, outer casing 130, and vanes 132. Output housing 110 can include shaft casing 134, gearbox casing 136, and mounting flange 138. Gear system 112 can include sun gear 140, planet gears 142, output carrier 144, ring gear 146, gear support 148, and bearings 150. In the example of FIG. 1, air turbine starter 100 can also include shaft bearings 152, at least one clutch bearing 154, face seals 156, and bearing support sleeve 158.

As shown in FIG. 1, discharge housing 102, center housing 106, output housing 110, bearing support sleeve 158, and gear support 148 are stationary components that support and house clutch 104, transfer shaft 108, and gear system 112. Discharge housing 102 forms a first end of air turbine starter 100 and output shaft 114 forms a second end of air turbine starter 100. Hub 116 of discharge housing 102 is on center axis CA of air turbine starter 100 and outer casing 120 is spaced radially outward of hub 116 relative to center axis CA and extends circumferentially around hub 116 and center axis CA. Struts 118 extend radially from hub 116 to outer casing 120 such that hub 116, struts 116, and outer casing 120 form a rigid frame. Outer casing 120 and hub 116 together form a flow path for airflow AF to pass axially through discharge housing 102.

Center housing 106 is connected to an upstream end of discharge housing 102. Inner casing 128 of center housing 106 extends circumferentially around center axis CA. Outer casing 130 of center housing 106 is connected to outer casing 120 of discharge housing 102 and extends circumferentially around inner casing 128. Outer casing 120 is radially spaced from inner casing 128 to form a flow inlet for air turbine starter 100. Vanes 132 extend radially from inner casing 128 to outer casing 130 of center housing 106. Vanes 132 condition the airflow AF before the airfoil AF reaches turbine blades 126. As shown in the example of FIG. 1, center housing 106 and discharge housing 102 can together house and support clutch 104, which includes turbine blades 126.

Clutch 104 forms a turbine section of air turbine starter 100. Base 125 of input component 124 of clutch 104 is rotationally connected to hub 116 of discharge housing 102 by the at least one clutch bearing 154 such that input component 124 can rotate about center axis CA while hub 116 remains stationary. Input component 124 includes turbine blades 126 that extend radially outward from base 125 relative to center axis CA into the flow path of discharge housing 102. When the airflow AF passes over vanes 132 to enter air turbine starter 100, the airflow AF interacts with turbine blades 126 to rotate turbine blades 126 and the rest of input component 124 of clutch 104. Face seals 156 can be positioned on both sides of input component 124 to prevent the airflow AF from leaking into clutch 104. Turbine blades 126 are integral with the rest of input component 124, such that input component 124 with turbine blades 126 form a single component of air turbine starter 100. Input component 124 is mechanically coupled to output component 122 such that input component 124 can drive output component 122 but input component 124 will overrun freely relative to output component 122 should the rotational speed of output component 122 exceed the rotational speed of input component 124. In other words, clutch 104 can be an overrun clutch.

Transfer shaft 108 extends axially from output component 122 of clutch 104 to gear system 122 along center axis CA. A first end of transfer shaft 108 is connected to output component 122 of clutch 104. A second end of transfer shaft 108 is connected to gear system 122. Bearing support sleeve 158 can extend circumferentially around transfer shaft 108 and provides a stationary housing for transfer shaft 108. Shaft bearings 152 are between transfer shaft 108 and bearing support sleeve 158 and support transfer shaft 108 within bearing support sleeve 158. In the example of FIG. 1, shaft casing 134 of output housing 110 extends circumferentially around bearing support sleeve 158 and is connected to inner casing 128 of center housing 106. Shaft casing 134 houses and protects bearing support sleeve 158 and transfer shaft 108. Gearbox casing 136 of output housing 110 is connected to shaft casing 134 and houses gear system 112. Mounting flange 138 can be formed on gearbox casing 136 and can be used to fasten air turbine starter 100 to an accessory gearbox of a gas turbine engine or to another part of the gas turbine engine.

In the example of FIG. 1, gear system 112 is a planetary gear system. Sun gear 140 is connected to the second end of transfer shaft 108. Ring gear 146 extends circumferentially around sun gear 140. Ring gear 146 can be connected to gear support 148 to maintain ring gear 146 stationary relative to sun gear 140 and planet gears 142. Planet gears 142 are meshed between sun gear 140 and ring gear 146. When transfer shaft 108 and sun gear 140 rotate, planet gears 142 rotate about center axis CA between ring gear 146 and sun gear 140. Each of planet gears 142 is connected to output carrier 144 by one of bearings 150. Output carrier 144 can be connected to gear support 148 by one of bearings 150 such that output carrier 144 can rotate relative to stationary gear support 148. Output shaft 114 extends axially from output carrier 144 along center axis CA.

During operation of air turbine starter 100, air turbine starter 100 is coupled to a high-pressure fluid source (not shown) that provides the airflow AF to air turbine starter 100. The high-pressure fluid source can include an auxiliary power unit (APU) of an aircraft, a second propulsion gas turbine engine typical of a multi-engine aircraft, or a ground cart, for example. As the airflow AF enters air turbine starter 100 through center housing 106, the airflow AF passes across turbine blades 126 of clutch 104 and through discharge housing 102. As the airflow AF passes across turbine blades 126, the airflow AF rotates the turbine blades 126. As turbine blades 126 are an integral part of input component 124 of clutch 104, rotation of turbine blades 126 causes rotation of input component 124 of clutch 104. As input component 124 rotates, input component 124 causes output component 122 and transfer shaft 108 to rotate. Rotation of output component 122 and transfer shaft 108 drives rotation of sun gear 140. Rotation of sun gear 140 drives rotation of planet gears 142, output carrier 144 and output shaft 114.

Air turbine starter 100 thus can convert pneumatic energy from the relatively high pressure of airflow AF into mechanical energy that is outputted from air turbine starter 100 through output shaft 114. The mechanical energy outputted through output shaft 114 can be used to rotate a shaft of a gas turbine engine for spool-up. As the shaft of the gas turbine engine increases in rotational speed due to combustion within the gas turbine engine, the shaft of the gas turbine engine can begin to drive output shaft 114, gear system 112, and transfer shaft 108. As clutch 104 is an overrun clutch, output component 122 cannot transfer rotational energy to input component 124. Thus, input component 124 can rotate at a speed independent to output component 122 when the rotational speed of output component 122 exceeds the rotational speed of input component 124.

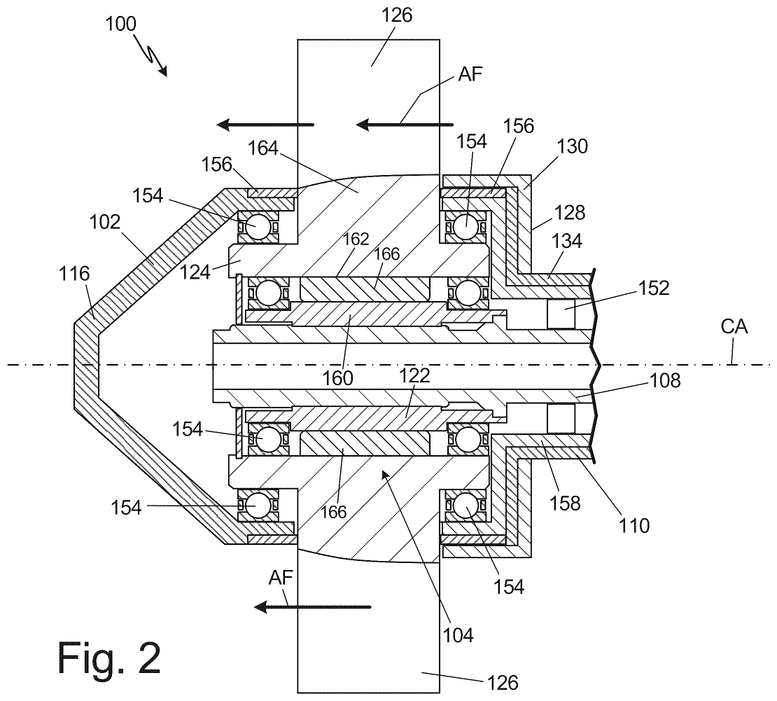

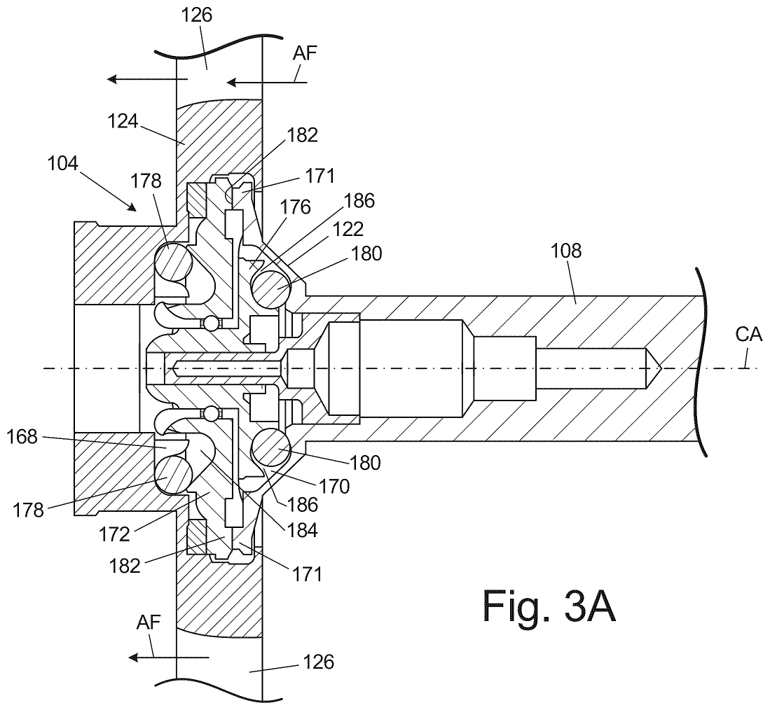

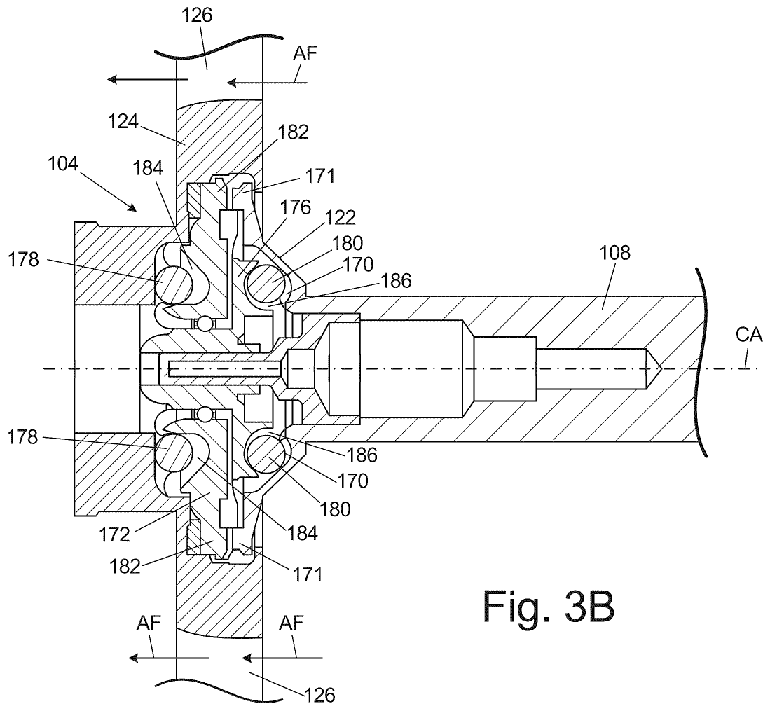

In some examples, clutch 104 can include a pawl and ratchet mechanism incorporated between input component 124 and output component 122. In other examples, clutch 104 can include a sprag mechanism incorporated between input component 124 and output component 122. In another example, clutch 104 can be a synchronous engagement clutch. In other examples, clutch 104 can include a wrapped spring mechanism, a roller ramp mechanism, a wedge ramp mechanism, and/or any other mechanism that allows input component 124 to overrun relative to output component 122 when output component 122 is rotating at a faster speed than input component 124. FIG. 2 shows one non-limiting example of clutch 104 incorporating a sprag mechanism between input component 124 and output component 122. FIGS. 3A and 3B show a non-limiting example of clutch 104 incorporating a synchronous engagement mechanism between input component 124 and output component 122.

FIG. 2 is a cross-sectional view of but one example of clutch 104 of air turbine starter 100. In the example of FIG. 2, clutch 104 is a sprag-styled clutch. Output component 122 of clutch 104 includes inner race 160. Input component 124 of clutch 104 includes outer race 162. Turbine blades 126 are connected to outer race 162 by base 164. In the example of FIG. 2, clutch 104 also includes sprags 166 between inner race 160 and outer race 162. As shown in FIG. 2, outer race 162, base 164, and turbine blades 126 are all integrally formed as a single part to form input component 124 of clutch 104. Inner race 160 is disposed radially inward from outer race 162 and forms output component 122. Output component 122 is connected to transfer shaft 108 such that output component 122 and transfer shaft 108 rotate together. Clutch bearings 154 are disposed radially between inner race 160 and outer race 162 relative to center axis CA. Clutch bearings 154 can also be disposed radially between outer race 162 and hub 116, and radially between outer race 162 and inner casing 128. Sprags 166 are positioned radially between inner race 160 and outer race 162. Sprags 166 mechanically engage both outer race 162 and inner race 160 when input component 124 is rotating faster than output component 122 and transfer shaft 108. Sprags 166 slip between outer race 162 and inner race 160 when a rotational speed of output component 122 exceeds a rotational speed of input component 124.

FIGS. 3A and 3B show a cross-sectional view of another example of clutch 104 of air turbine starter 100. In the example of FIGS. 3A and 3B, clutch 104 is a synchronous engagement clutch. Input component 124 of clutch 104 includes engagement pockets 168. Output component 122 includes disengagement pockets 170 and output teeth 171. Clutch 104 further includes ball guide input 172, ball guide output 176, engagement weights 178, and disengagement weights 180. Ball guide input 172 includes drive teeth 182 and engagement groove 184. Ball guide output 176 includes disengagement pockets 186. In FIG. 3A, clutch 104 is in an engaged position with output teeth 171 meshed with drive teeth 182. FIG. 3B shows clutch 104 in an overrun position with output teeth 171 not meshed with drive teeth 182.

As shown in FIGS. 3A and 3B, ball guide input 172 is positioned axially between input component 124 and output component 122 relative to center axis CA. Ball guide output 176 is positioned axially between ball guide input 127 and output component 124 relative to center axis CA. Engagement groove 184 is formed in ball guide input 127 and extends circumferentially about center axis CA. Engagement groove 184 faces input component 124 and includes a radially outer side wall that is ramped and slopes radially outward as the radially outer side wall extends axially toward input component 124. Engagement groove 184 forms a track that houses engagement weights 178. Drive teeth 182 are formed on ball guide input 172 and face toward output component 122. Engagement pockets 168 are formed on input component 124 and face engagement groove 184. Engagement weights 178 are weighted spherical balls that are trapped between engagement pockets 168 and engagement groove 184. Ball guide input 172 engages with input component 124 such that ball guide input 172 can axially translate relative to input component 124 relative to center axis CA. However, ball guide input 172 engages with input component 124 such that ball guide input 172 is rotationally coupled to input component 124 and rotates with input component 124.

Output teeth 171 are formed in output component 122 and face drive teeth 182. Disengagement pockets 186 are formed in ball guide output 176 and face output component 122. Disengagement pockets 170 are formed in output component 122 and face disengagement pockets 186 of ball guide output 176. Disengagement weights 180 are weighted spherical balls that are trapped between disengagement pockets 186 and disengagement pockets 170.

Ball guide output 176 engages with output component 122 such that ball guide output 176 can axially translate relative to output component 122 relative to center axis CA. However, ball guide output 176 engages with output component 122 such that ball guide ouput 176 is rotationally coupled to output component 122 and rotates with output component 122. A bearing can be disposed between ball guide output 176 and ball guide input 172 such that ball guide output 176 and ball guide input 172 can rotate relative to one another.

The disengagement pockets 170, 186 are respectively contoured to provide generally decreasing axial space between each other with increasing radial distance from center axis CA. Outward travel of disengagement weights 180 in a radial direction caused by rotation of output component 122 therefore biases ball guide output 176 and ball guide input 172 axially away from output component 122 and toward input component 124.

The engagement groove 184 and engagement pockets 168 are respectively contoured to generally provide decreasing axial distance between each other with increasing radial distance from center axis CA. Thus, radially outward travel of the engagement weights 178 biases ball guide input 172 and ball guide output 176 toward output component 122. Such outward travel by engagement weights 178 can be caused by centrifugal force when turbine blades 126 of input component 124 are rotating about center axis CA.

In the example clutch 104 shown in FIGS. 3A and 3B, when the airflow AF passes across turbine blades 126 of input component 124, the airfoil AF causes input component 124 to rotate about center axis CA. Rotation of input component 124 also causes ball guide input 172 to rotate. As input component 124 and ball guide input 172 are rotating, engagement weights 178 travel radially outward inside of engagement groove 184 and engagement pockets 168. As engagement weights 178 travel radially outward relative to center axis CA, engagement weights 178 push ball guide input 172 and ball guide output 176 axially toward output component 122 such that drive teeth 182 contact and mesh with output teeth 171, as shown in FIG. 3A. With drive teeth 182 and output teeth 171 meshed together, output component 122 and transfer shaft 108 are rotationally locked with input component 124 and rotationally driven by input component 124.

As shown in FIG. 3B, should transfer shaft 108 and output component 122 exceed a rotational speed of input component 124, the centrifugal forces acting on output component 122 and ball guide output 176 will cause disengagement weights 180 to travel radially outward inside of disengagement pockets 170, 186. As disengagement weights 180 travel radially outward relative to center axis CA, disengagement weights 180 push ball guide output 176 and ball guide input 172 axially toward input component 124. Since output component 122 and ball guide output 176 are rotating at a speed greater than the speed of input component 124 and ball guide input 172, the lateral force generated by disengagement weights 180 on ball guide output 176 and ball guide input 172 is greater than the lateral force created by engagement weights 178. Thus, in this scenario, disengagement weights 180 cause ball guide output 176 and ball guide input 172 to translate axially toward input component 124 which causes drive teeth 182 to disengage with output teeth 171. With drive teeth 182 disengaged from output teeth 171, input component 124 is able to freewheel relative to output component 122 when output component 122 and transfer shaft 108 are rotating faster than input component 124.

Clutch 104 discussed above with respect to FIGS. 1-3B provides numerous benefits and advantages to air turbine starter 100 over prior starter systems. Clutch 104 functions as both a clutch and a turbine section for air turbine starter 100, thereby causing air turbine starter to have a smaller envelope size and weight in comparison to prior air turbine starters. A gas turbine engine that includes air turbine starter 100 will be lighter and thus more fuel efficient than a similar gas turbine engine that incorporates a prior air turbine starter. Integrating a turbine section of air turbine starter 100 into clutch 104 also reduces the part count and complexity of air turbine starter 100, which translates into reduced maintenance costs and manufacturing costs for air turbine starter 100.

### Discussion of Possible Embodiments

The following are non-exclusive descriptions of possible embodiments of the present invention.

An air turbine starter for a gas turbine engine includes a clutch with an input component and an output component. The input component includes a base and turbine blades connected to the base and extending radially outward from the base relative to a center axis of the air turbine starter. An overrun mechanism connects the base of the input component to the output component and is configured to transfer rotational energy from the input component to the output component and prevent the output component from transferring rotational energy to the input component. A first end of a transfer shaft is connected to the output component of the clutch. A gear system is connected to a second end of the transfer shaft. An output shaft is mechanically connected to the transfer shaft by the gear system.

The air turbine starter of the preceding paragraph can optionally include, additionally and/or alternatively, any one or more of the following features, configurations and/or additional components in the paragraphs below.

In an embodiment of the foregoing air turbine starter, the overrun mechanism is selected from at least one of a sprag mechanism, a wrapped spring mechanism, a roller ramp mechanism, a wedge ramp mechanism, a pawl and ratchet mechanism, and a synchronous engagement mechanism.

In an embodiment of the foregoing air turbine starter, the air turbine starter further comprises: a discharge housing comprising: an outer casing extending circumferentially around the center axis and the clutch; a hub radially within the outer housing; a flow path extending axially between the outer casing and the hub; and struts extend radially from the hub to the outer casing and connecting the hub and the outer casing together, and wherein the turbine blades extend radially into the flow path.

In an embodiment of the foregoing air turbine starter, the air turbine starter further comprises: a bearing between the hub of the discharge housing and the base of the input component of the clutch.

In an embodiment of the foregoing air turbine starter, the air turbine starter further comprises: a center housing comprising: an inner casing extending circumferentially around the center axis; a second outer casing extending circumferentially around the inner casing and radially spaced from the inner casing relative the center axis to form a flow inlet; and vanes extending radially from the inner casing to the second outer casing.

In an embodiment of the foregoing air turbine starter, the discharge housing and the center housing enclose the clutch.

In an embodiment of the foregoing air turbine starter, the base and the turbine blades of the input component of the clutch are formed integral to one another to form a single part.

In an embodiment of the foregoing air turbine starter, the gear system is a planetary gear system comprising: a sun gear connected to the second end of the transfer shaft; a stationary ring gear extending circumferentially around the sun gear; planet gears radially between the sun gear and the stationary ring gear; and a carrier connected to the planet gears and connected to the output shaft.

In an embodiment of the foregoing air turbine starter, the air turbine starter further comprises: an output housing enclosing the gear system and at least a portion of the transfer shaft.

In another example of the disclosure, a clutch for an air turbine starter includes an input component and an output component. The input component includes a base and a plurality of turbine blades extending radially outward from the base relative to a center axis. An overrun mechanism connects the base of the input component to the output component and is configured to transfer rotational energy from the input component to the output component and prevent the output component from transferring rotational energy to the input component.

The clutch of the preceding paragraph can optionally include, additionally and/or alternatively, any one or more of the following features, configurations and/or additional components in the paragraphs below.

In an embodiment of the foregoing clutch, the overrun mechanism is selected from at least one of a sprag mechanism, a wrapped spring mechanism, a roller ramp mechanism, a wedge ramp mechanism, a pawl and ratchet mechanism, and a synchronous engagement mechanism.

In an embodiment of the foregoing clutch, the base and the turbine blades of the input component of the clutch are formed integral to one another to form a single part.

In another example of the disclosure, a turbine section of an air turbine starter includes a clutch. The clutch includes an input component and an output component. The input component comprises a base and turbine blades connected to the base and extending radially outward from the base relative to a center axis of the air turbine starter. An overrun mechanism connects the base of the input component to the output component and is configured to transfer rotational energy from the input component to the output component and prevent the output component from transferring rotational energy to the input component.

The turbine section of the preceding paragraph can optionally include, additionally and/or alternatively, any one or more of the following features, configurations and/or additional components in the paragraphs below.

In an embodiment of the foregoing turbine section, the overrun mechanism is selected from at least one of a sprag mechanism, a wrapped spring mechanism, a roller ramp mechanism, a wedge ramp mechanism, a pawl and ratchet mechanism, and a synchronous engagement mechanism.

In an embodiment of the foregoing turbine section, the base and the turbine blades of the input component of the clutch are formed integral to one another to form a single part.

In an embodiment of the foregoing turbine section, the turbine section further comprises: a discharge housing comprising: an outer casing extending circumferentially around the center axis and the clutch; a hub radially within the outer housing; a flow path extending axially between the outer casing and the hub; and struts extend radially from the hub to the outer casing and connecting the hub and the outer casing together, and wherein the turbine blades extend radially into the flow path.

In an embodiment of the foregoing turbine section, the turbine section further comprises: a bearing between the hub of the discharge housing and the base of the input component of the clutch.

In an embodiment of the foregoing turbine section, the turbine section further comprises: a center housing comprising: an inner casing extending circumferentially around the center axis; a second outer casing extending circumferentially around the inner casing and radially spaced from the inner casing relative the center axis to form a flow inlet; and vanes extending radially from the inner casing to the second outer casing.

In an embodiment of the foregoing turbine section, the discharge housing and the center housing enclose the clutch.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An air turbine starter for a gas turbine engine comprises:
a clutch comprising:
an input component, wherein the input component comprises a base and turbine blades connected to the base and extending radially outward from the base relative to a center axis of the air turbine starter;
an output component; and
an overrun mechanism connecting the base of the input component to the output component and configured to transfer rotational energy from the input component to the output component and prevent the output component from transferring rotational energy to the input component;
a transfer shaft comprising a first end and a second end, wherein the first end is connected to the output component of the clutch;
a gear system connected to the second end of the transfer shaft, wherein the gear system is a planetary gear system comprising:
a sun gear connected to the second end of the transfer shaft;
a stationary ring gear extending circumferentially around the sun gear;
planet gears radially between the sun gear and the stationary ring gear; and
a carrier connected to the planet gears;
an output shaft, wherein the output shaft is mechanically connected to the transfer shaft by the gear system, wherein the carrier is connected to the output shaft; and
wherein the turbine blades are positioned axially over the overrun mechanism relative to the center axis.

2. The air turbine starter of claim 1, wherein the overrun mechanism is selected from at least one of a sprag mechanism, a wrapped spring mechanism, a roller ramp mechanism, a wedge ramp mechanism, a pawl and ratchet mechanism, and a synchronous engagement mechanism.

3. The air turbine starter of claim 2, further comprising:
a discharge housing comprising:
an outer casing extending circumferentially around the center axis and the clutch;
a hub radially within the outer casing;
a flow path extending axially between the outer casing and the hub; and
struts extend radially from the hub to the outer casing and connecting the hub and the outer casing together, and
wherein the turbine blades extend radially into the flow path.

4. The air turbine starter of claim 3, further comprising:
a bearing between the hub of the discharge housing and the base of the input component of the clutch.

5. The air turbine starter of claim 4, further comprising:
a center housing comprising:
an inner casing extending circumferentially around the center axis;
a second outer casing extending circumferentially around the inner casing and radially spaced from the inner casing relative the center axis to form a flow inlet; and
vanes extending radially from the inner casing to the second outer casing.

6. The air turbine starter of claim 5, wherein the discharge housing and the center housing enclose the clutch.

7. The air turbine starter of claim 6, wherein the base and the turbine blades of the input component of the clutch are formed integral to one another to form a single part.

8. (canceled)

9. The air turbine starter of claim 1, further comprising:
an output housing enclosing the gear system and at least a portion of the transfer shaft.

10. A clutch for an air turbine starter comprising:
an input component, wherein the input component comprises a base and a plurality of turbine blades extending radially outward from the base relative to a center axis;
an output component; and
an overrun mechanism connecting the base of the input component to the output component and configured to transfer rotational energy from the input component to the output component and prevent the output component from transferring rotational energy to the input component, and
wherein the turbine blades are positioned axially over the overrun mechanism relative to the center axis.

11. The clutch of claim 10, wherein the overrun mechanism is selected from at least one of a sprag mechanism, a wrapped spring mechanism, a roller ramp mechanism, a wedge ramp mechanism, a pawl and ratchet mechanism, and a synchronous engagement mechanism.

12. The clutch of claim 11, wherein the base and the turbine blades of the input component of the clutch are formed integral to one another to form a single part.

13. A turbine section of an air turbine starter comprising:
a clutch comprising:
an input component, wherein the input component comprises a base and turbine blades connected to the base and extending radially outward from the base relative to a center axis;
an output component; and
an overrun mechanism connecting the base of the input component to the output component and configured to transfer rotational energy from the input component to the output component and prevent the output component from transferring rotational energy to the input component, and
wherein the turbine blades are positioned axially over the overrun mechanism relative to the center axis.

14. The turbine section of claim 13, wherein the overrun mechanism is selected from at least one of a sprag mechanism, a wrapped spring mechanism, a roller ramp mechanism, a wedge ramp mechanism, a pawl and ratchet mechanism, and a synchronous engagement mechanism.

15. The turbine section of claim 14, wherein the base and the turbine blades of the input component of the clutch are formed integral to one another to form a single part.

16. The turbine section of claim 15, further comprising:
a discharge housing comprising:
an outer casing extending circumferentially around the center axis and the clutch;
a hub radially within the outer casing;
a flow path extending axially between the outer casing and the hub; and
struts extend radially from the hub to the outer casing and connecting the hub and the outer casing together, and
wherein the turbine blades extend radially into the flow path.

17. The turbine section of claim 16, further comprising:
a bearing between the hub of the discharge housing and the base of the input component of the clutch.

18. The turbine section of claim 17, further comprising:
a center housing comprising:
an inner casing extending circumferentially around the center axis;
a second outer casing extending circumferentially around the inner casing and radially spaced from the inner casing relative the center axis to form a flow inlet; and
vanes extending radially from the inner casing to the second outer casing.

19. The turbine section of claim 17, wherein the discharge housing and the center housing enclose the clutch.
